(19) United States
(12) Patent Application Publication
(10) Pub. No.: US 2016/0033438 A1
(43) Pub. Date: Feb. 4, 2016

(54) Paper-Based Reference Electrode And Potentiometric Ion Sensing

(71) Applicants: PRESIDENT AND FELLOWS OF HARVARD COLLEGE, Cambridge, MA (US); REGENTS OF THE UNIVERSITY OF MINNESOTA, Minneapolis, MN (US)

(72) Inventors: Wenjie LAN, Somerville, MA (US); Elizabeth Jane MAXWELL, Ottawa (CA); Claudio PAROLO, Padova (IT); David BWAMBOK, Allston, MA (US); Martin Mwangi THUO, Watertown, MA (US); Anand Bala SUBRAMANIAM, Cambridge, MA (US); George M. WHITESIDES, Newton, MA (US); Xu U. ZOU, Minneapolis, MN (US); Jinbo HU, St. Paul, MN (US); Philippe BUHLMANN, Minneapolis, MN (US); Mahiar Max HAMEDI, Cambridge, MA (US)

(21) Appl. No.: 14/777,051

(22) PCT Filed: Mar. 3, 2014
(86) PCT No.: PCT/US14/19869

§ 371 Date: Sep. 15, 2015

Related U.S. Application Data
(60) Provisional application No. 61/789,883, filed on Mar. 15, 2013.

(51) Int. Cl. G01N 27/30; B01L 3/00; G01N 27/416

(52) U.S. Cl. CPC G01N 27/301; G01N 27/4161; B01L 3/502715; B01L 2300/0645; B01L 2300/161; B01L 2300/126

(57) ABSTRACT

Microfluidic, electrochemical devices are described. The microfluidic, electrochemical device may include a sample zone on a first porous, hydrophilic layer, a reference zone and a microfluidic channel, wherein the microfluidic channel provides for predominantly diffusive fluid communication between the sample zone and the reference zone; (therefore realizing a similar function of a reference electrode), a fluid-impermeable material that defines each of the sample zone, reference zone and microfluidic channel, a first electrode in fluid communication with the sample zone and a second electrode in fluid communication with the reference zone. Also described are microfluidic, electrochemical devices containing an ion-selective membrane for potentiometric ion sensing.

### CROSS REFERENCE TO RELATED APPLICATION

This application claims the benefit of U.S. Provisional Patent Application No. 61/789,883, filed Mar. 15, 2013, the contents of which are hereby incorporated by reference.

### BACKGROUND

The present application relates to paper-based reference electrodes, and more particularly, to microfluidic devices containing a paper-based reference electrode and an integrated electrochemical cell.

Electrochemical analyses are ubiquitous in analytical laboratories. A stable reference electrode is indispensable for accurate electroanalytical measurements of certain types (e.g., voltammetry, or measurements of pH and concentrations of ions). Conventional, glass-bodied silver/silver chloride (Ag/AgCl) reference electrodes are expensive (prices range from ˜$25 to $100), fragile, difficult to transport, and require storage in a concentrated solution of chloride ions (Cl⁻) when not in use. These characteristics are incompatible with point-of-care or field-based measurements, which require devices that are portable, inexpensive, and accurate.

In recent years, microfluidic systems have attracted increasing interests due to their diverse and widespread potential applications. For example, using very small volumes of samples, microfluidic systems could carry out complicated biochemical reactions to acquire important chemical and biological information. Among other advantages, microfluidic systems reduce the required amount of samples and reagents, shorten the response time of reactions, and decrease the amount of biohazard waste for disposal.

First developed in the early 1990s, microfluidic devices were initially fabricated in silicon and glass using photolithography and etching techniques adapted from the microelectronics industry. Current microfluidic devices are constructed from plastic, silicone, or other polymeric materials, e.g. polydimethylsiloxane (PDMS). Such devices are generally expensive, inflexible, and difficult to construct.

The selective quantitation of electrolyte ions in solution is an important tool for clinical diagnosis, environmental monitoring, and quality control. Measurements of this type are routinely performed in laboratory settings using potentiometric ion-selective electrodes (ISEs); the cost and fragility of conventional ISEs, however, limit their application in the field, or in resource-limited environments.

Electrochemical analysis involves methods of measuring the potential and/or current between electrodes immersed in a fluidic sample containing analytes, and is widely used in the medicinal field or in environmental studies. Electrochemical analysis usually utilizes sophisticated instruments and is conducted by specially-trained technicians. However, for use in developing countries, in the field, or in-home heath-care settings, there remains a need for analytical devices that are inexpensive, disposable, portable, and easy to construct and use.

There are presently several hand-held micro-electrochemical diagnostic products on the market, such as personal glucose meters and the i-STAT® clinical analyzer, based on amperometric or potentiometric determination of analytes in human blood. The miniaturized reference electrodes used in these systems generally resemble scaled-down versions of conventional reference electrodes, and thus require sealing of the inner reference solution with a protective layer, and the implementation of a micro junction between the reference solution and the sample. The fabrication of these three-dimensional structures often requires lithography or chip manufacturing techniques that are complicated and not suitable for application to disposable electrochemical devices.

Paper can be used as a hydrophilic matrix that holds an aqueous fluid (serum, electrolyte, sample) in a thin film without forming a gel. Electrochemical Paper-based Analytical Devices (EPADs) have recently been explored as the basis for low-cost, portable devices, especially for use in public-health and point-of-care diagnosis. EPADs generally employ a printed Ag/AgCl “pseudo-reference electrode” whose potential (AgCl(s)+e⁻⇄Ag(s)+Cl⁻(aq)) depends on the concentration of chloride ions in the sample solution. These devices therefore cannot maintain a stable potential unless a high concentration of soluble chloride salts is added to the sample prior to measurement. To make the full range of electrochemical measurements accessible, a paper-based reference electrode would be very useful.

### SUMMARY

Described herein is a paper-based microfluidic, electrochemical device for conducting electrochemical assays requiring a separate reference electrode. In accordance with certain embodiments, the devices are low cost, disposable devices. The devices may provide for multiplexed analysis and pipette-free sampling and can be constructed for single use.

In one aspect, the microfluidic, electrochemical device includes a sample zone on a porous, hydrophilic layer, a hydrophilic region comprising a reference zone and a microfluidic channel. The microfluidic channel provides for predominantly diffusive fluid communication between the sample zone and the reference zone. A fluid-impermeable material defines each of the sample zone, reference zone and microfluidic channel. The device also includes an electrode or two electrodes in fluid communication with the sample zone and another electrode in fluid communication with the reference zone. In accordance with certain embodiments, the sample zone, reference zone and microfluidic channel may be disposed on the first, hydrophilic layer.

Additionally, the device may be a multiplexed device further including one or more additional sample zones and channels on the porous hydrophilic layer. For example, the microfluidic, electrochemical device may also include a second sample zone and a second microfluidic channel defined by the fluid impermeable material, wherein the second microfluidic channel provides for predominantly diffusive fluid communication between the second sample zone and the reference zone. The device may also include a third sample zone and a third microfluidic channel defined by the fluid impermeable material, wherein the third microfluidic channel provides for predominantly diffusive fluid communication between the third sample zone and the reference zone. The device may include as many combinations of sample zones and corresponding microfluidic channels as can be utilized on the porous hydrophilic layer.

In accordance with another aspect, the microfluidic, electrochemical device may also include a sample inlet channel and/or a reference inlet channel providing fluid communication from an edge of the porous, hydrophilic layer to the sample zone. Again, the number of inlet channels that can be used is not particularly limited.

In accordance with certain aspects, the electrodes in the microfluidic, electrochemical device may be Ag/AgCl electrodes.

In accordance with another embodiment, a microfluidic device is provided that combines a reliable reference electrode with an ion-selective electrode (ISE) and provides a simple, affordable, and disposable tool for measuring the concentrations of specific ions in solution using potentiometry.

The microfluidic, electrochemical device may also include an ion-selective membrane (ISM) that separates the working (indicator) electrode from the sample solution. In accordance with a certain embodiment, the microfluidic, electrochemical device includes an ISM overlaying and contacting at least a portion of the first hydrophilic layer and a second porous, hydrophilic layer overlaying and contacting at least a portion of the ISM, wherein the second hydrophilic layer includes an inner filling zone defined by a fluid-impermeable material and the first electrode is disposed in the inner filling zone.

The porous, hydrophilic layer in the microfluidic, electrochemical device may be paper.

The present application is also directed to methods of determining the presence and/or concentration of one or more analytes in a fluidic sample using the microfluidic, electrochemical device described herein. In accordance with one aspect, the method includes introducing a fluidic sample into one of the one or more sample zones of the porous, hydrophilic layer to provide fluidic contact of the sample with the first electrode, introducing a reference solution into the reference zone of the porous, hydrophilic layer to provide fluidic contact of the reference solution with the second electrode and measuring an electrochemical signal using the electrode(s). In accordance with another aspect, the method includes introducing an inner filling solution into an inner filling zone to provide fluidic contact of the inner filling solution with the first electrode, introducing a fluidic sample into one sample zone of the porous, hydrophilic layer to provide fluidic contact of the sample with the sample zone, introducing a reference solution into the reference zone to provide fluidic contact of the reference solution with the second electrode and measuring an electrochemical signal using the electrode(s). The electrochemical signal may be correlated with the presence and/or concentration of the analyte(s). Specific examples of measuring of an electrochemical signal may include measurement of impedance, current or voltage. More particularly, the electrochemical measurement may involve amperometry, biamperometry, stripping voltammetry, differential pulse voltammetry, cyclic voltammetry, coulometry, chronoamperometry, or potentiometry.

In another aspect of the present application, systems including microfluidic, electrochemical devices as described herein and devices for measuring an electrochemical signal from the microfluidic, electrochemical devices are provided.

### BRIEF DESCRIPTION OF THE DRAWINGS

The subject matter is described with reference to the following figures, which are presented for the purpose of illustration only and are not intended to be limiting of the invention.

FIG. 1 provides schematic illustrations (a and b) and photographs (c and d) of a microfluidic, electrochemical device (referenced Electrochemical Paper-based Analytical Device, rEPAD) in accordance with one embodiment.

FIG. 2 shows (a) photograph and schematic illustration of a commercial Ag/AgCl reference electrode (CH Instruments, Inc.). (b) Front view and back view of a paper-based electrochemical device (rEPAD). The paper was patterned by wax printing to define the sample zone, central mixing zone, reference zone, and microfluidic channels. The sample and reference zones include stencil-printed carbon and Ag/AgCl electrodes, respectively. The arrows with the same number as in (a) refer to similar functions. The dashed lines indicate the approximate boundaries of the carbon and Ag/AgCl ink printed on the back.

FIG. 3 illustrates cyclic voltammograms of 1 mM K₃[Fe(CN)₆] solution at various scan rates obtained from (a) a rEPAD containing a paper-based reference electrode and (b) a commercial electrochemical cell that includes a 3-mm diameter glassy carbon-disk working electrode and a conventional Ag/AgCl electrode. 1 M aqueous solutions of KCl and 0.5 M solutions of KNO₃ were used as the internal filling solution of the reference electrode and supporting electrolyte in the sample solution, respectively. (c) Cyclic voltammogram of 1 mM K₃[Fe(CN)₆] solution obtained from a rEPAD using a reference solution of 0.5 M KNO₃ instead of 1M KCl.

FIG. 4 shows cathodic peak current (iₚ) as a function of (a) the concentration of K₃[Fe(CN)₆] and (b) the square root of the scan rate (v^{1/2}) for cyclic voltammetry experiments conducted on rEPADs. The solid lines represent a linear fit to (a) with regression equation: y=0.16+1.4×(R²=0.998, n=7), and a linear fit to (b) with regression equation: y=−0.65+0.42×(R²=0.995, n=7).

FIG. 5 provides (a) photograph of a multiplexed rEPAD. Three pairs of carbon working and counter electrodes (located at the top, bottom left, and bottom right of the Figure) share the same Ag/AgCl electrode (bottom middle); this design allows electrochemical analysis of three (or by extension of the design, more) different samples simultaneously. (b), (c), and (d) Cyclic voltammograms obtained from a single rEPAD shown in (a) for analysis of three different analytes: 1 mM potassium hexachloroiridate (IV) (K₂IrCl₆) in 0.1 M aqueous KNO₃, 0.5 mM ferrocene (Fe(C₅H₅)₂) in acetonitrile solution with 0.1 M TBAPF₆, and 1 mM hexaammineruthenium (III) chloride (Ru(NH₃)₆Cl₃) in 0.1 M aqueous KNO₃. 10 μL each of the sample and reference solutions were added to the respective zones of a device with no sealing tape. The measurements were performed at a scan rate of 50 mV/s.

FIG. 6 shows (a) photograph of a sealed rEPAD with the capability of performing both sample application and on-site sample analysis. Microfluidic channels are defined at the corners of the paper device. The dashed lines indicate the boundaries of the tape covered on top of the device. (b) Schematic illustration of an electrochemical cell containing a sealed rEPAD. The rEPAD is attached to a glass slide by double-sided tape, with the electrode side facing the slide, in order to minimize gravity-driven fluid flow, which might cause the contamination of sample or reference zones. Drops of the sample and reference solutions were added to the top of the corresponding inlets to allow controlled and continuous wicking into the device. (c) Time-dependent voltammetric curves obtained from a sealed rEPAD shown in (a) with 1 mM K₃[Fe(CN)₆] as the sample and 1M KCl as the reference solution.

FIG. 7 provides (a) photograph of a Cl⁻-sensing Electrochemical Paper-based Analytical Device (EPAD). The paper was patterned by wax printing to define the sample zone, central contact zone, reference zone, and microfluidic channels. The sample and reference zones include stencil-printed Ag/AgCl electrodes. (b) Photograph of 28 potentiometric Cl⁻-sensing EPADs fabricated on one page of wax-printed paper (20 cm by 20 cm).

FIG. 8 provides (a) Photograph of two wax-printed paper layers in an ion-sensing EPAD for K⁺, Na⁺, and Ca²⁺. Ag/AgCl ink was stencil-printed on paper to make the indicator and reference electrodes. (b) The PVC-based ion-selective membrane and the indicator electrode were attached sequentially to the sample zone of the EPAD. (c) Schematic illustration (cross-sectional view) of an assembled paper-based potentiometric device.

FIG. 9 provides (a) schematic illustration of conventional potentiometric measurements. (b) and (c) Front view of paper components of a paper-based electrochemical device (EPAD). The paper was patterned by wax printing to define the sample zone, central mixing zone, reference zone, and microfluidic channels. The sample and reference zones include stencil-printed Ag/AgCl electrodes. The arrows with the same number as in (a) refer to similar functions.

FIG. 10 shows potentiometric response obtained from Cl⁻-sensing EPADs (inset). The calibration plot after addition of the reference solution (1 M KCl) and various sample solutions is shown. The solid line represents a linear fit to (▪) between 10⁻³ and 1 M KCl with regression equation: y=−13.9−60.4×(R²=0.999).

FIG. 11a is a (a) photograph of an assembled ion-sensing EPAD for potentiometric measurement of K⁺, Na⁺, and Ca²⁺, in accordance with one embodiment. The EPAD was sandwiched between two PVC boards using binder clips. (b) Potentiometric response of EPAD to different concentrations of K⁺ in an aqueous KCl solution. A 10⁻³ M KCl solution was used as the inner filling and the reference solution. (c) The solid line represents a linear fit to (▪) within the range between 10⁻⁴ and 0.1 M KCl with regression equation: y=162.4+56.4×(R²=0.997).

FIG. 12 provides potentiometric responses of ion-sensing EPADs to (a) Na⁺ in aqueous NaCl solutions and (b) Ca²⁺ in aqueous CaCl₂ solutions. A Na⁺ ISM and a Ca²⁺ ISM were incorporated in corresponding EPADs. A 0.1 M NaCl solution (for Na⁺ sensing) and a 0.01 M CaCl₂ solution (for Ca²⁺ sensing) were used as the inner filling solution. 1 M aqueous solutions of KCl were used as the reference solution.

### DETAILED DESCRIPTION

Described herein is a microfluidic device that includes two or more electrodes, one microfluidic channel, one sample zone and one reference zone. These structures of the device are deposited on hydrophilic layers patterned by fluid-impermeable materials that define one or more hydrophilic channels or regions (zones) on the patterned hydrophilic layer. One method of preparing patterned hydrophilic layers is described in detail in PCT Publication No. 2008/049083, the content of which is incorporated in its entirety by reference. A method of preparing a microfluidic device including one or more electrodes is described in detail in PCT Application No. PCT/US2010/026499, the content of which is incorporated in its entirety by reference.

In accordance with another embodiment, a method of determining the presence and/or concentration of one or more analytes in a fluidic sample using the microfluidic, electrochemical device described herein is provided. In one embodiment, a fluidic sample is introduced into one of the one or more sample zones of the porous, hydrophilic layer to provide fluidic contact of the sample with the first electrode (or pair of electrodes) and a reference solution is introduced into the reference zone of the porous, hydrophilic layer to provide fluidic contact of the reference solution with the second electrode and then an electrochemical signal is measured using the electrode(s).

By controlling mass transfer within paper channels (convective during filling; diffusive in use), the electrochemical paper-based analytical device disclosed herein is capable of performing direct and accurate voltammetric measurements that are referenced by an electrode with a constant, well-known potential. The performance of rEPADs in both qualitative and quantitative analysis using cyclic voltammetry is comparable to a commercial electrochemical cell. The geometry of the device can be designed to provide a multiplexed system that enables simultaneous determination of multiple analytes in a single device.

The rEPADs, in accordance with certain embodiments, have several advantages over commercial reference electrodes and conventional electrochemical cells: (i) they may be made of paper, which is inexpensive, lightweight, portable, and easily disposable (single use), (ii) they can eliminate the need for storage of the electrode in a solution of KCl, and (iii) they may be fabricated in a planar structure, and are thus appropriate for mass fabrication with roll-to-roll printing.

Certain embodiments of the rEPADs disclosed herein also have advantages over other miniaturized electrochemical devices: (i) the reference electrode is separate and thus provides a well-defined potential, (ii) the layout can be easily modified, depending on the intended analytical purpose, (iii) the fabrication process does not require complicated thin-film microfabrication or chip manufacturing processes, and (iv) they are compatible, to a limited extent, with samples prepared in non-aqueous solvents (e.g., CH₃CN). Compared to other paper-based reference electrodes, some rEPADs may have a simpler structure (two layers) and provide a fully integrated paper-based electrochemical cell that includes the working and counter electrodes.

These devices are particularly suited for single-use applications that require a separate reference electrode or an accurate reference potential, or in cases where chloride ions may interfere with the electrochemical experiment. Combining rEPADs with other, previously demonstrated functions of paper-based devices, including valving, sample pre-concentration, and storage or immobilization of reagents for (bio) chemical assays, should enable more advanced forms of analysis in rEPAD-based systems. The concept may also be extended to the construction of electrochemical devices based on other low-cost materials such as nitrocellulose, cloth, nylon, cotton string, silk, etc.

The microfluidic devices disclosed herein can be used in a variety of applications. Examples of suitable applications include, but are not limited to, chronoamperometry, cyclic voltammetry, square-wave voltammetry, and differential pulse voltammetry.

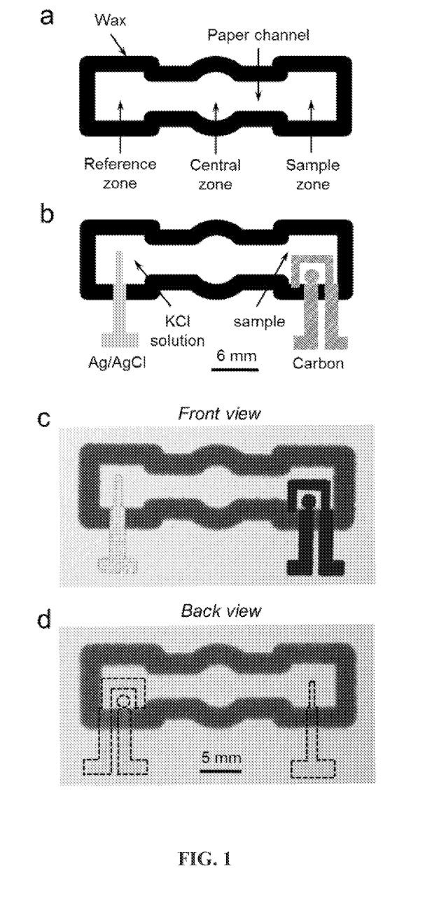

A microfluidic device having a paper-based electrode according to some embodiments is described with reference to FIG. 1 which provides schematic illustrations (a and b) and photographs (c and d) of a referenced Electrochemical Paper-based Analytical Device (rEPAD) in accordance with one embodiment. The porous hydrophilic layer (e.g., paper) includes a sample zone, central contact zone, reference zone, and microfluidic channels defined by a fluid impermeable material (e.g., wax). The sample and reference zones include stencil-printed carbon and Ag/AgCl electrodes, respectively. The dashed lines in (d) indicate the approximate boundaries of the carbon and Ag/AgCl ink printed on the back.

When two different solutions are added to the sample and reference zones, capillarity pulls the liquids (aqueous solution of electrolytes such as potassium chloride) along the microfluidic channels to the central zone. Once the liquids meet and completely saturate the hydrophilic network of cellulose fibers, there is no longer a capillary driving force and, thus, bulk convective transport of liquid stops. Instead, diffusional transport, due to concentration gradients across the interface between the two liquids, dominates the mass transfer within the device (subtle differences in the hydrodynamic pressure between the zones may result in mass transfer by convection, but this contribution is considered to be negligible).

In some embodiments, the device, system, and method described herein can be used to analyze the ratios and concentrations of multiple analytes within the same sample.

In some embodiments, an electrochemical reader, as used herein, refers to an amperometric device that detects the existence of certain analytes.

In some embodiments, the patterned hydrophilic layer is a patterned paper layer.

In some embodiments, paper is used as the substrate for electrochemical detection because it is inexpensive, and easy to pattern channels using wax printing. Electrodes can be screen-printed or stencil-printed electrodes using conductive carbon ink and silver/silver chloride ink. Carbon ink can also be used for wire material as well. Possible electrode materials include any conductive material, including metals (silver, gold, platinum, copper, etc.), mixtures of metals and metallic salts (silver/silver chloride), carbon-based materials (carbon black, graphite, graphene, carbon nanotubes), organic conductors (conductive polymers), or ionic conductors (ionic hydrogels, ionic liquids). The electrodes made from conductive ink have several advantages: (i) they are less expensive, compared to Au or Pt electrodes; (ii) the fabrication process is simple, and has less requirements on cleanroom facilities; (iii) those materials are well developed, and easy to obtain, because they are widely used in both industrial and academic research; (iv) screen printing is capable of mass production at low cost.

Porous, hydrophilic layers include any hydrophilic substrate that wicks fluids by capillary action. In one or more embodiments, the porous, hydrophilic layer is paper. Non-limiting examples of porous, hydrophilic layers include chromatographic paper, filter paper, nitrocellulose and cellulose acetate, cellulosic paper, filter paper, paper towels, toilet paper, tissue paper, notebook paper, Kim Wipes, VWR Light-Duty Tissue Wipers, Technicloth Wipers, newspaper, any other paper that does not include binders, cloth, and porous polymer film. In general, any paper that is compatible with the selected patterning method may be used. In certain embodiments, porous, hydrophilic layers include Whatman chromatography paper No. 1.

In some embodiments, the electrode and the hydrophilic regions can be treated with chemicals to increase the hydrophilicity. Non-limiting examples of such chemical agents include 3-aminopropyldimethylethoxysilane (APDES).

Non-limiting examples of fluid-impermeable material comprise wax and polymerized photoresist. The photoresist used for patterning porous, hydrophilic material include SU-8 photoresist, SC photoresist (Fuji Film), poly(methylmethacrylate), nearly all acrylates, polystyrene, polyethylene, polyvinylchloride, and any photopolymerizable monomer that forms a hydrophobic polymer.

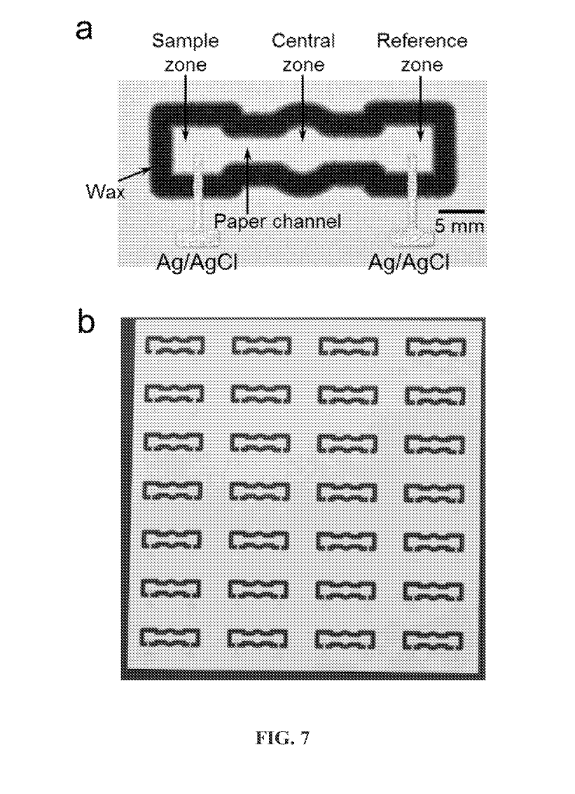

As shown in FIG. 7b, one page of chromatography paper (20 cm by 20 cm) can be used to fabricate multiple devices, in this case, 28 devices. Other paper portions of the ion-sensing device can also be mass produced in the same way. Although there are advantages to fabricating the device as a planar structure, the present application is not limited to planar structures but also includes multilayer devices that provide for fluid communication from one layer to another.

### Paper-Based Potentiometric Ion Sensing

In accordance with another aspect of the present application, the paper-based electrodes can be used in combination with an ion-selective membrane to provide a potentiometric sensor.

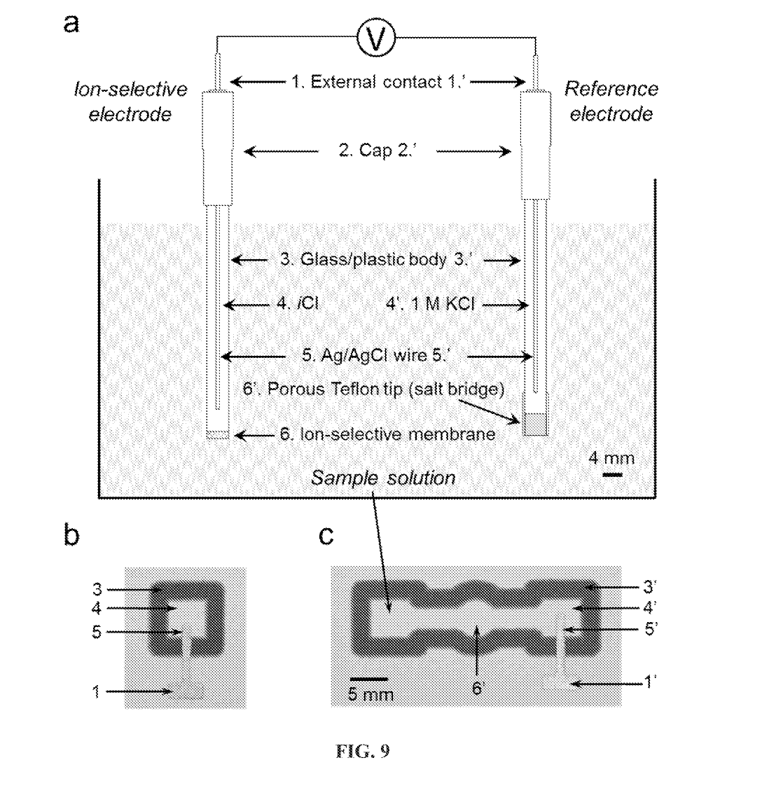

“Potentiometry” is an electrochemical method that passively measures the difference in potential between an indicator electrode and a reference electrode (FIG. 9a). The indicator electrode used when measuring ions (often referred to as ion-selective electrode, or ISE), is selective in its response to species (i) of interest due to the presence of an ion-selective membrane (ISM), whereas the reference electrode is not. The observed potential is a type of phase boundary potential that develops across the interface between the sample and the ISM that separates the analyte solution from a reference solution (FIG. 9a). The analyte concentration in the sample is determined through the Nernst equation, which relates the measured potential (electromotive force, EMF) to the ion activity.

$$EMF = {E}^{o} + \frac{RT}{{z}_{i} F} ln {a}_{i} = {E}^{o} + \frac{59.2 [ mV ]}{{z}_{i}} log {a}_{i} \qquad ( 1 )$$

where R, T, and F are, respectively, the gas constant, room temperature, and Faraday's constant. zᵢ is the charge of species i in solution, and aᵢ is the activity for species i. The constant term E^{o} is evaluated by calibrating the device before the measurement with a standard solution having a known activity for species i. By measuring EMF, the analyte concentration in the sample can be determined. The ISE therefore serves as a transducer that converts the activity of i into an electrical potential depending on the logarithm of the activity.

The microfluidic, electrochemical device may also include an indicator electrode constructed from a material that is selective to specific analytes in the sample solution, such as Ag/AgCl electrode (sensitive to Cl⁻ and Ag⁺ ions), copper indicator electrode (sensitive to Cu²⁺ ions), a Pt/Pd/Au electrode (sensitive to a redox system), or a carbon-nanotube electrode (sensitive to protons or ammonium).

### Conventional Ion-Selective Electrodes (ISEs)

One of the most common potentiometric devices that use an ISE is the pH meter, which uses a glass membrane electrode to measure proton concentration in samples.

The development of ISEs based on ISMs in 1960s allowed potentiometry to replace flame photometry (flame atomic emission spectroscopy) as the standard technique for the measurement of electrolyte ions in physiological fluids and other environmental or industrial samples. Today, well over a billion measurements are performed annually with potentiometry.

An ideal ISE must respond rapidly and reproducibly to changes in activity or concentration of the analyte ion. A wide variety of conventional ISEs are available from commercial sources that permit selective determination of numerous cations and anions by direct potentiometric measurements.

For the measurement of electrolytes, the ISM typically contains a lipophilic ion receptor (an ionophore) and, in an optimized molar ratio, a lipophilic ion exchanger, both incorporated into a polymeric membrane matrix such as plasticized poly(vinyl chloride) (PVC). All components are dissolved into tetrahydrofuran (THF), and result in an ISM cocktail. After spotting the cocktail solution onto a substrate, the THF evaporates and the ionophore-containing PVC membrane is formed.

### Miniaturized Potentiometric Devices

The i-STAT® clinical analyzer is a commercial handheld micro-electrochemical device that measures a broad range of clinically important analytes in blood, including potassium ion (K⁺), sodium ion (Na⁺), chloride ion (Cl⁻), ionized calcium (Ca²⁺), proton, CO₂, O₂, urea nitrogen, and glucose in blood. The i-STAT measures electrolyte concentrations by potentiometry with membrane-based ISEs which are fabricated using wafer-scale, high-volume, planar, thin-film microfabrication techniques.

Paper-based electrochemical devices (EPADs) in accordance with certain embodiments are capable of quantifying the concentrations of heavy-metal ions, glucose, cholesterol, lactate, and ethanol in aqueous solutions. The EPADs are also able to provide accurate voltammetric measurements that are referenced by an electrode with a constant, well-defined potential. The devices are easy to fabricate, portable, and inexpensive.

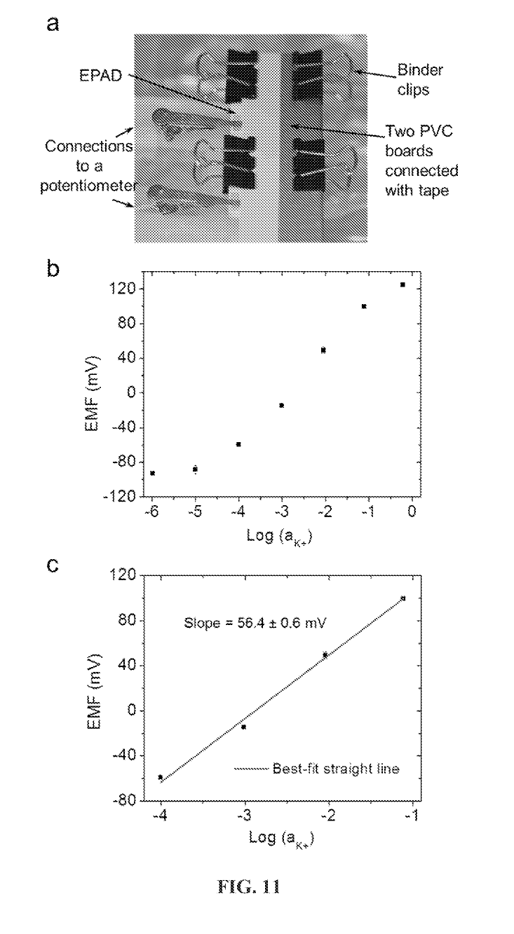

The devices disclosed herein may include one or more support layers (PVC boards in FIG. 11a). The support layer(s) typically will be positioned as an outer layer of the device. In accordance with certain embodiments, support layers are positioned on each side of the device and sandwich the device. The support layer, may be a board or film capable of supporting the rest of the device. In accordance with certain embodiments, the support may be comprised of a rigid polymer, such as PVC. It is noted however, that the polymeric identity is not critical. In accordance with certain aspects, the support is gas impermeable. Typically, the support layer will have a thickness of about 0.5 mm. As shown, the support layer comprises a single layer. It is to be understood however, that the support layer may actually comprise a multi-layered structure.

### Fabrication and Design of the Device

Because the efficiency of the present device depends on the concentration of the solutions in the reference and sample zones, and not in the zone of contact, experiments were conducted to determine if the sample and reference have constant concentrations within their respective zones. The channels of the rEPADs in FIG. 1 were sealed with transparent tape to prevent evaporation, and a solution of cobalt chloride (CoCl₂, pink) was placed in contact with the left inlet of the rEPADs, and copper sulfate (CuSO₄, blue) with the right inlet. The pink Co²⁺ ions arrived at the zone of contact in less than 15 minutes, due to the wicking of the liquid. Following this initial rapid transport of liquid, no pink Co²⁺ was observed diffusing into the right zone for 2 hours, and vice versa. After 2 hours, the device began to dry by evaporation, as indicated by a color change. The time required for evaporation was much shorter (˜20 min) in devices that were not sealed with tape.

The time required for an ionic species to diffuse from the interface of contact to the sample or reference zone was estimated using the Einstein relation (eq 2). Assuming one-dimensional diffusion (a reasonable assumption since the thickness of the paper is about 200 μm and the length of the channel is ˜5 mm), the distance that an ion diffuses, σ, during the time period, t, following mixing, can be estimated as:

σ²=2Dt, (2)

where D is the diffusion coefficient of the ion (typically ranges from 10⁻⁸ to 10⁻¹⁰ m²/s). Thus, an ion would require approximately 10³ to 10⁵ seconds (˜20 min-1 day) to diffuse 5 mm. As these times are much longer than the duration of a typical electrochemical measurement (<3 min), we conclude that diffusion is unlikely to appreciably change the concentration of ions in the sample and reference zones of the rEPADs. Theoretically, by lengthening the channel by a factor of ten (plausibly using a serpentine pattern to keep the footprint of the rEPAD small), the times required become very long (˜1 day to ˜4 months).
rEPADs for Voltammetry
Geometry of Voltammetric rEPADs

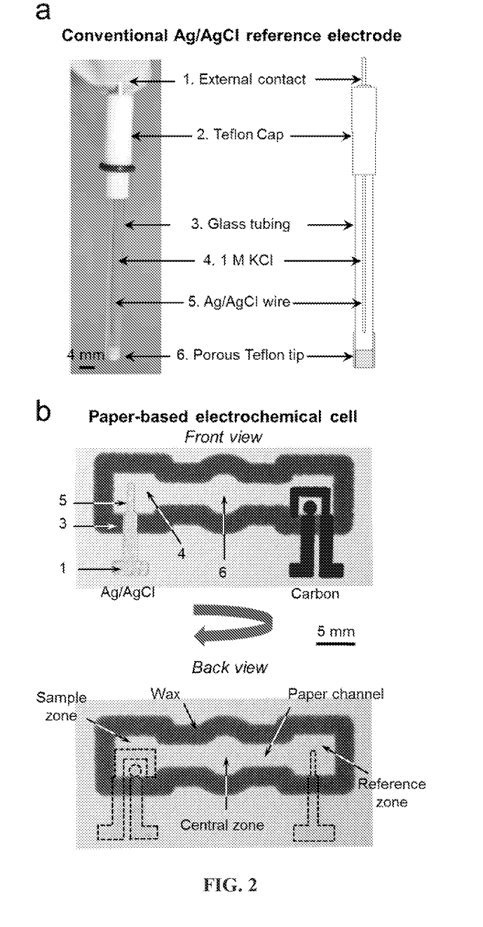

Having determined that the ionic constituents in the reference and sample zones were sufficiently isolated, electrodes were added to the device by stencil-printing carbon and Ag/AgCl inks in the sample and reference zones, respectively, as shown in FIG. 1. The addition of reference and sample solutions to the designated paper zones hydrates the paper “salt bridge” and generates a properly referenced electrochemical system. This geometry allows physical contact and ionic conductivity between the reference and working electrodes, while preventing large-scale convection that would alter the analyte concentration and shift the potential of the reference electrode. The central zone therefore operates in a manner similar to the porous plug or fit used in the commercial reference electrode (FIG. 2, arrow 6). Other parts in the paper device (labeled by the arrows) perform functions similar to those of their conventional counterparts (marked in FIG. 2 with the same numbers).

### Influence of the Reference Solution on Peak Potentials in Voltammetry

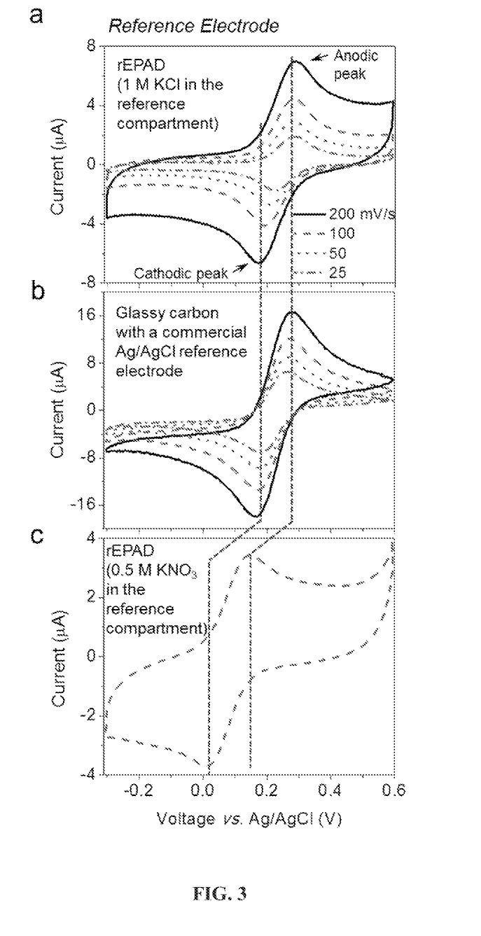

Cyclic voltammetry, which provides both qualitative and quantitative information (oxidation/reduction potential, half-cell potential, reaction rates, and concentrations), was used to compare the performance of the rEPAD (FIG. 1b-d) with that of a conventional three-electrode system. FIG. 3 shows the effect of the reference solution on the peak potentials for the redox reaction of potassium ferri/ferrocyanide (Fe(CN)₆³⁻(aq)+e⁻⇄Fe(CN)₆⁴⁻(aq)), as measured by cyclic voltammetry. By using rEPADs and a reference solution of 1 M KCl, anodic and cathodic peak potentials (FIG. 3a) for the ferri/ferrocyanide couple were estimated to be 0.28±0.01 and 0.19±0.02 V, respectively. These results are in good agreement with the peak potentials (0.28±0.02 and 0.17±0.02 V) obtained using the same sample solution and commercial electrodes (a 3-mm glassy carbon disk working electrode, a platinum-mesh counter electrode, and a commercial Ag/AgCl reference electrode).

In contrast, the same rEPADs operating without chloride ions in the reference solution—an arrangement similar to that of a Ag/AgCl pseudo-reference electrode in direct contact with the sample solution—showed a large shift (˜0.15 V, FIG. 3c) in the peak potentials. The peak shift is due to the ill-defined potential of this quasi-reference electrode, and corresponds to a decrease of approximately three orders of magnitude in the concentration of chloride ions in the solution bathing the Ag/AgCl electrode, based on calculations from the Nernst equation (0.059 V per decade). Under these experimental conditions, the whole paper-based electrochemical cell is no longer properly referenced, and the voltage information obtained by the voltammetric curves is not accurate.

### Quantitative Measurements by Cyclic Voltammetry

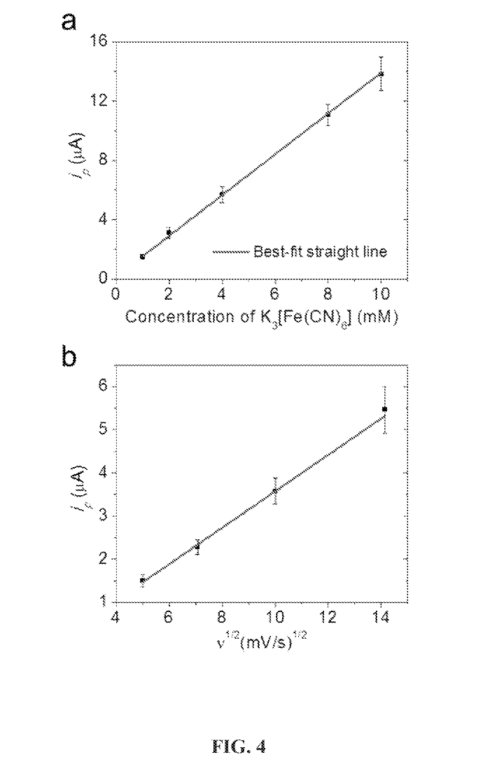

The stability of the voltage measurement provided by the rEPAD allows one to use cyclic voltammetry to obtain quantitative information about the concentration of analyte. FIG. 4a demonstrates a linear relationship between the cathodic peak current, iₚ, at a scan rate of 25 mV/s and the concentration of K₃[Fe(CN)₆] in the range of 1 to 10 mM (a typical range for cyclic voltammetry), in agreement with the Randles-Sevcik equation (eq 3). In this equation, n is the number of electrons transferred per analyte, A is the electrode area, Dₒ is the diffusion coefficient of the analyte, Cₒ* is the bulk concentration of the analyte, and v is the scan rate of the applied potential (V/s).

iₚ=(2.69×10⁵)n^{3/2}ADₒ^{1/2}C*ₒυ^{1/2} (3)

Cyclic voltammetry is not an ideal method for accurate quantitation of the concentration of an electroactive species, because the correction for the non-Faradaic charging current is typically uncertain. When properly referenced, the method does, however, provide an estimate of the analyte concentration; more importantly, the peak potentials, and the shape of the voltammetric curves, provide a qualitative study of redox processes and an understanding of the electrochemical mechanism of the system.

FIG. 4b shows that the cathodic peak current (1 mM K₃[Fe(CN)₆]) is linearly proportional to the square root of the scan rate (ν^{1/2}) in the rEPAD; this result indicates a reversible wave and diffusion-controlled mass transfer towards the working electrode, in accordance with the expected characteristics of the ferri/ferrocyanide redox couple.

rEPADs for Multiplexed Voltammetry

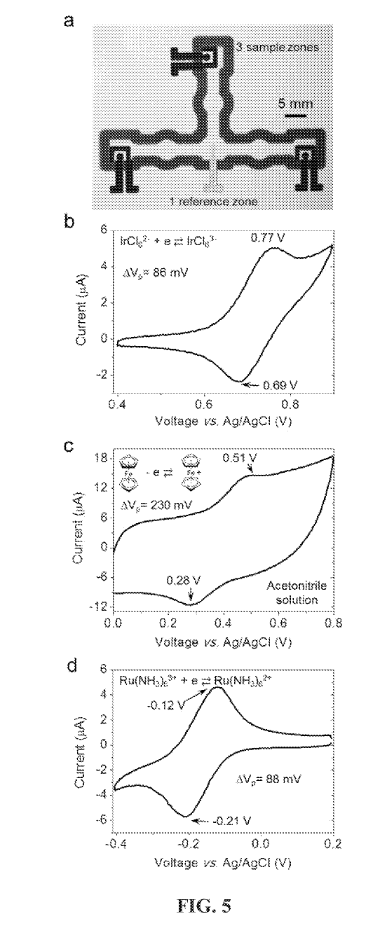

The paper-based reference electrodes disclosed herein can also be used in producing a multiplexed system that permits multiple samples to be analyzed simultaneously. FIG. 5a shows three separate electrochemical systems in a single device; the sample zones share the same reference electrode without cross contamination. This arrangement would be difficult to achieve with commercial electrochemical cells; an equivalent system would require three separate sample vials, each containing a working and counter electrode, connected via salt bridges to a fourth vial containing the reference electrode.

The multiplexed rEPADs as shown in FIG. 5 were utilized to test three different redox couples, Ru(NH₃)₆^{3+/2+} (1 mM), IrCl₆^{2-/3-} (1 mM), and ferrocene/ferrocenium (0.5 mM). These samples were selected because they have very different peak potentials, and because they are widely used as standard redox couples for evaluating the performance of electrochemical devices, and as calibrants for unknown species. FIG. 5b-d show that the three samples are clearly distinguished based on the peak potentials.

The relatively large capacitive current and peak splitting (˜0.2 V) for the ferrocene/ferrocenium redox couple in acetonitrile (FIG. 5c) may be due to the interaction between the rough surface of the carbon electrode and the organic solvents used in the paper-based device. The signal/noise ratio can be enhanced, however, by reducing the scan rate of the voltage. The peak currents in FIG. 5 are close to each other, a consequence of the similar diffusion coefficient between redox couples.

Acetonitrile was used to dissolve the ferrocene and tetrabutyl ammonium hexafluorophosphate (TBAPF₆). The wax boundaries were able to contain the acetonitrile within the hydrophilic region as long as only a small volume of solution (several μL) was used. Other electrochemical devices based on a Ag/AgCl pseudo-reference electrode cannot be used to analyze samples prepared in a solvent, such as acetonitrile, that does not dissolve KCl.

rEPAD for Pipette Free Sample Introduction and Extended Lifetime

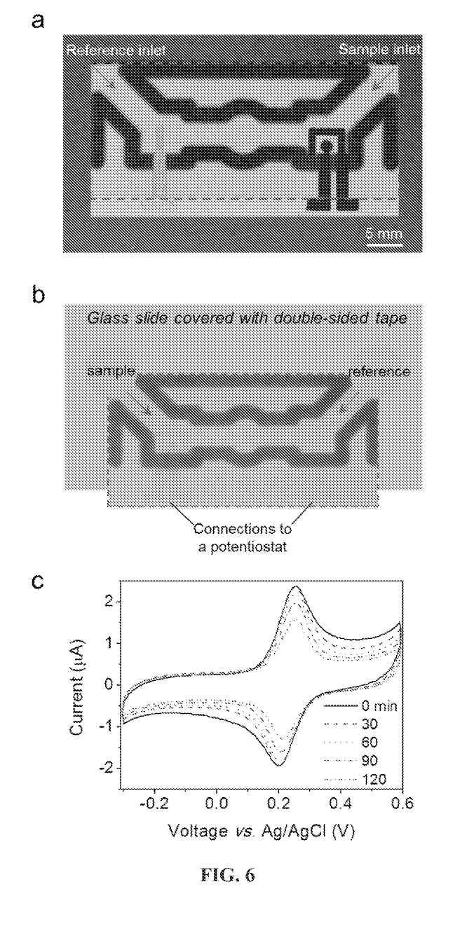

In accordance with certain embodiments, the rEPAD can be designed to enable application of the sample and/or reference solutions by dipping, and eliminate the need for a pipette or injection device. In order to extend the lifetime of the device, a fluid-impermeable layer, such as tape, can be applied to the top and bottom of the device to minimize the rate of solvent evaporation. FIG. 6a shows a device that includes inlets at the device corners to spontaneously wick solutions into the adjacent zones.

Repeated cyclic voltammetry measurements were performed to investigate the working lifetime of the rEPADs. The sealed device in FIG. 6a was functional for approximately 1.5 h (at T˜23° C., RH˜15%) after the application of sample (it takes about 15 min for the solutions to wick into the device and mix). As shown in FIG. 6c, the peak potentials remain the same, indicating that the reference electrode is stable. It is believed that the reason for the decrease of the peak current with increasing time may be due to the diffusion of the sample away from the working electrode, or adsorption of the analyte molecules onto the electrode surface.

### Experimental

Chemicals:

Carbon ink (E3456) and Ag/AgCl ink (E2414) were purchased from Ercon Inc. (Wareham, Mass.). Potassium nitrate (KNO₃) was purchased from Alfa Aesar. Cupric sulfate (CuSO₄.5H₂O) was purchased from Mallinckrodt. Potassium chloride (KCl), cobalt(II) chloride (CoCl₂), potassium ferricyanide (K₃[Fe(CN)₆]), potassium hexachloroiridate(IV) (K₂IrCl₆), ferrocene (Fe(C₅H₅)₂), hexaammineruthenium(III) chloride (Ru(NH₃)₆Cl₃), tetrabutylammonium hexafluorophosphate (TBAPF₆), and acetonitrile were purchased from Sigma-Aldrich and used as received.

Electrochemical Supplies:

Glassy carbon disk working electrodes (3-mm diameter, part # CHI 104) and Ag/AgCl reference electrodes with 1 M KCl internal filling solution (Part # CHI 111) were purchased from CH Instruments, Inc. A platinum gauze (Stock #10283, Alfa Aesar) was used as the counter electrode. The working electrodes were polished before voltammetric experiments using a polishing kit (CHI 120) from CH Instruments.

Fabrication of the Device:

paper-based zones and microfluidic channels were fabricated by patterning chromatography paper (Whatman 1 Chr) by wax printing. Electrochemical analytical devices were fabricated by stencil-printing carbon ink or Ag/AgCl ink on the wax-printed paper. A stencil was generated for printing by designing patterns of electrodes using AutoCAD® 2012, followed by cutting the pattern into frisket films (Grafix, low tack) using a laser-cutter (VersaLASER VLS3.50, Universal Laser Systems Inc.). The stencil was adhered on top of the paper, and the openings of the stencil were filled with ink. The film was removed carefully. The ink was then cured by baking the electrodes in an oven at ˜100° C. for 15-20 min. The reference and sample solutions were added to the corresponding zones using a pipette. For the sealed devices, a Fellowes® self-adhesive sheet (Staples) was cut and attached to the top and bottom of the device to minimize the effect of evaporation.

Device Geometry:

the carbon working electrode is a 1.5-mm diameter disk electrode while the carbon counter electrode has a larger surface area and surrounds the working electrode (see FIG. 1). For voltammetric applications, rEPADs were designed such that the carbon working and counter electrodes were stencil-printed on the right side of the device and the Ag/AgCl reference electrode (Ag/AgCl ink associated with the KCl solution) on the tell side.

Cyclic Voltammetry:

Cyclic voltammetry (CV) was performed with paper-based devices (or a commercial electrochemical cell) and a potentiostat (Pine Instrument Co., AFCBPl) interfaced to a computer through a PCI-MIO-16E-4 data acquisition board (National Instruments) for potential and current measurements. Voltammetric data were recorded using in-house virtual instrumentation Pinechem 2.7.9a (Pine instruments).

### Convection in the Paper-Based Devices

Because the same small amount of the solution (10 μL) was pipetted to each zone and because of the design of the device, the mass transfer in the fluid-filled channel due to convection is negligible, i.e., the convection is not strong enough to drive the solution from one side to the other side of the device, in fact, even when 10 μL was applied only to the left zone, the solution stopped at the light-hand part of the microfluidic channel and did not wick into the right zone.

### Lifetime of Paper-Based Devices

The effect of sealing the devices with tape was investigated on working time of the rEPADs without printed electrodes. The uncovered devices dried completely within 20 minutes, while the sealed devices remained wet for more than 24 h.

The lifetime for the rEPADs with printed electrodes is significantly shorter than the drying time for the unprinted devices because the layer of the electrodes creates a gap between the paper layer and the tape layer that allows water vapor to escape. This gap, however, can be filled by inserting a layer of parafilm or other filler materials, if longer device lifetime is desired.

### Peak Splitting in Cyclic Voltammetry

The average potential differences between the anodic and cathodic peak potentials (ΔEₚ) of Ru(NH₃)₆^{3+/2+} and IrCl₆^{2-/3-} were 88.4 and 86.4 mV, respectively, as shown in FIG. 5. These values are slightly higher than the theoretical value for an ideal reversible one-electron redox system (59 mV at 25° C.), and may result from the ohmic resistance of the solution. The difference in potentials between the cathodic and anodic peaks became larger at higher concentrations (>10 mM) in the rEPADs. This “splitting” is often observed as a consequence of the sluggish, heterogeneous kinetics at the surface of the carbon electrodes.

### Paper-Based Potentiometric Ion Sensing EPADs Design and Fabrication

The ion-sensing EPADs include a sample zone and a reference zone that each contains a Ag/AgCl electrode. The measurement zones are connected by a paper-based microfluidic channel that includes a central contact zone (FIG. 7a). The geometry of the EPAD shown in FIG. 7a allows ionic conductivity between the two solutions, while preventing convection that would shift the potential of the reference electrode and affect the accuracy of potentiometric measurement.

Devices for sensing chloride ions required no further modification, as the potential of the Ag/AgCl electrode is proportional to the logarithm of the ionic activity of chloride ions, as defined by the redox reaction (AgCl(s)+e⁻⇄Ag(s)+Cl⁻(aq)) and the Nernst equation. Thus, the Cl⁻ concentration in the sample can be obtained by applying a reference solution of KCl with known concentration on the reference zone and measuring the potential difference between the two Ag/AgCl electrodes. The ion-sensing EPADs are fabricated in a planar structure, and thus appropriate for mass fabrication with roll-to-roll printing. As shown in FIG. 7b, one page of chromatography paper (20 cm by 20 cm) can be used to fabricate 28 devices.

The potentiometric measurements of other electrolytes such as sodium (Na⁺), potassium (K⁺), and calcium ions (Ca²⁺) require the addition of an ISM that separates the indicator electrode (ISE) from the sample solution. A conventional ISM that contains an ionophore and ionic sites in a thin (<200 μm) PVC membrane matrix was used for this purpose.

In accordance with a particular embodiment, the ISM contains an ionophore and ionic sites in a thin (typically <200 μm) PVC membrane matrix. The ISMs are sensitive to specific ions of interest. In accordance with certain embodiments, conventional ISMs were selected because: (i) they can be easily fabricated by spotting a small volume (1.5 to 4.0 mL) of cocktail solution onto a petri dish (see Experimental Section for detailed formulations), (ii) they have been well-investigated and commercialized, (iii) they are small (typically smaller than 2 cm in diameter) and easy to handle, and (iv) the PVC membrane matrix has the mechanical robustness required for it to be incorporated into paper devices, and the potential for low-cost mass fabrication.

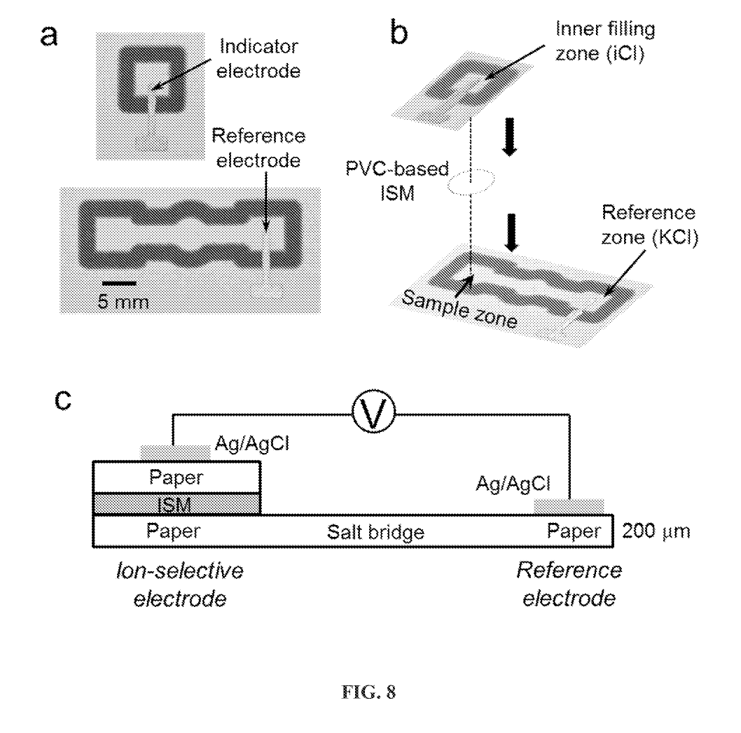

An additional wax-printed paper layer with a Ag/AgCl electrode printed on the top was included in the structure to serve as the indicator electrode, as shown in FIG. 8a. The wax barrier operates in a manner similar to the glass/plastic electrode body used in conventional ISEs (FIG. 9, arrow 3). Other parts in the paper device (labeled by the arrows) perform functions similar to those of their conventional counterparts. The paper components of the ion-sensing EPAD for K⁺, Na⁺, and Ca²⁺ can also be mass fabricated.

The ISM and the indicator electrode were attached sequentially to the sample zone of the EPAD (FIG. 8). The configuration of the assembled paper device resembles scaled-down version of a conventional potentiometric measurement setup as shown in FIG. 9. A schematic illustration (cross-sectional view) of the assembled ion-sensing EPAD is provided in FIG. 8c.

### Potentiometric Measurement of CT

A potentiometer can be used to measure the potential difference (EMF) between the two paper electrodes for aqueous KCl samples with different concentrations of Cl⁻. Aqueous 1 M KCl was used as the reference solution. The measured potential was recorded for at least 5 min after the solutions were applied to the zones.

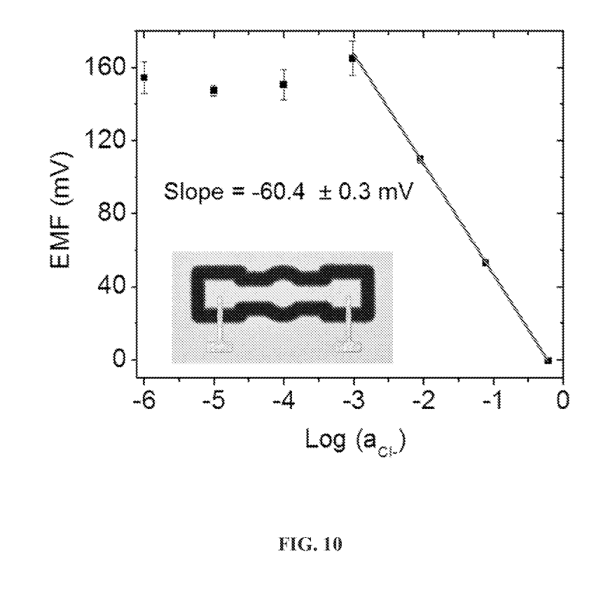

FIG. 10 shows that Cl⁻-sensing EPADs exhibit a Nernstian linear response for concentrations of KCl over three orders of magnitude in concentration (10⁻³ to 1 M), with a slope that is close to the theoretical value (−60.4±0.3 mV vs. a theoretical value of −59 mV). These results indicate that EPADs can be used to measure the concentration of Cl⁻ over a range that is relevant to various industrial, environmental, and clinical samples (98-109 mM in blood serum).

The potentiometric reading of Cl⁻-sensing EPADs leveled off when the concentration of KC sample is decreased to lower than 10⁻³ M. Although not wishing to be bound by theory, this effect is thought to be due to the solvation of the small amount of soluble chloride salts contained in the Ag/AgCl ink during the measurements.

The Cl⁻-sensing results of EPADs disclosed herein demonstrate the capability of measuring Cl⁻ concentration in aqueous samples with a simple and disposable paper-based device.

### Potentiometric Measurement of K⁺, Na⁺, and Ca²⁺

The fabricated ISMs were tested by integration of the ISM with a conventional PVC-based cylindrical electrode body. The electrode body was filled with an inner reference solution (iCl, depending on the type of ISM) and a Ag/AgCl wire was in contact with the solution to serve as the indicator electrode. The resulting ISE and a commercial Ag/AgCl reference electrode were immersed in a sample solution containing the corresponding ions of interest. The EMF was measured between two electrodes and a 2-fold serial dilution was used to obtain the calibration curve of the conventional ISE. The potentiometric response from the ISMs in the conventional configuration is in excellent agreement with the Nernst equation (59 mV per decade).

Since the PVC-based ISMs exhibited the anticipated Nernstian behavior, they were incorporated into paper devices enabling measurements of K⁺, Na⁺, and Ca²⁺ using ion-sensing EPADs. The inner filling solution (10⁻³ M KCl for K⁺, 0.1 M NaCl for Na⁺, and 0.01 M CaCl₂ for Ca²⁺), the sample, and the reference solution (10⁻³ M KCl for K⁺, 1 M KCl for Na⁺, and 1 M KCl for Ca²⁺) were spotted to respective zones of the EPADs shown in FIG. 8. As the solutions wicked through the device, a potential difference across the salt bridge is established once the reference and the sample solutions meet. The device was sandwiched between two supports (e.g., PVC boards) using binder clips, and the potential difference was measured between the paper reference electrode and the paper ISE (FIG. 11a).

PVC boards and binder clips were selected for this embodiment because: (i) they allow reversible attachment and easy disassembly between the ISM and paper layers, so that a single ISM can be calibrated and measured by multiple paper devices that are impregnated with calibrant or sample solutions, (ii) the PVC cover slows the rate of solvent evaporation, and (iii) the PVC boards keep the EPAD in a flat, horizontal position, thus minimizing the gravity-driven fluid flow, which might cause the contamination of sample or reference zones. FIG. 11b shows the response of the K⁺-sensing EPADs to varying concentrations of IC in aqueous KCl samples, A linear dependence was observed between the measured. EMF and the Log (a_{K+}) ranging from 10⁻⁴ to 0.1 M, with a slope of 56.4±0.6 mV, FIG. 11c, in accordance with the Nernst equation (59 mV), In addition, the linear (detection) range of the paper devices (10⁻⁴ to 0.1 M) is comparable to that of the conventional calibration (˜10⁻⁵ to 0.1 M), indicating the wax-printed paper layers and the paper reference electrode function as well as the plastic/glass electrode bodies and the commercial reference electrode used in conventional setups.

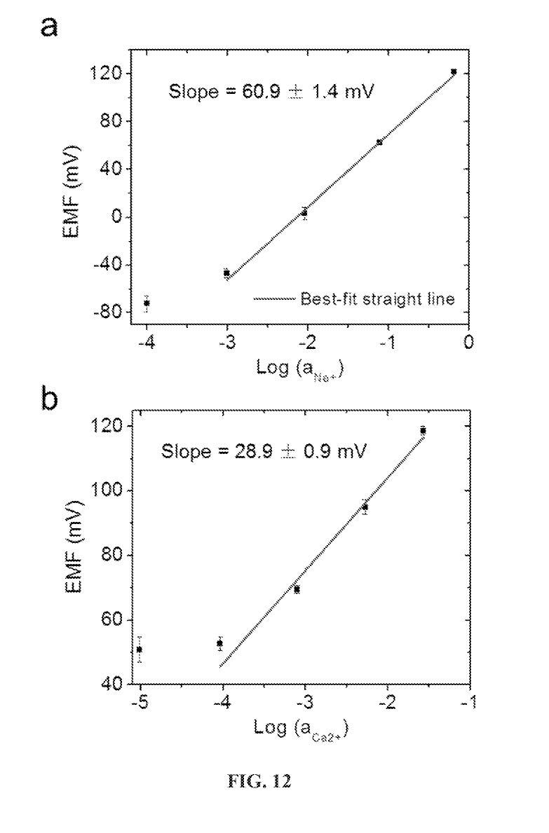

Measurements of Na⁺ with a Na⁺ ISM and paper devices resulted in a near-Nernstian relationship that has a slope of 60.9±1.4 mV between 10⁻³ and 1 M, FIG. 12a. Similarly, the measurement of EMF with different Ca²⁺ concentrations and a Ca²⁺ ISM led to a slope of 28.9±0.9 mV between 10⁻⁴ and 0.1 M (FIG. 12b).

The linear ranges of ion-sensing EPADs cover medically relevant concentrations of Na⁺, Na⁺, and Ca²⁺ in physiological fluids. For example, the concentrations of K⁺, Na⁺, and ionized calcium in human blood are, respectively, 3.5-4.9 mM, 138-146 mM, and 1.12-1.32 mM.

Although not wishing to be bound by theory, the small deviation in measurements using EPADs from the Nernstian response (59 and 29.5 mV per decade for K⁺/Na⁺ and Ca²⁺, respectively) and conventional measurements may be due to the difficulty in assembling the EPAD that has an ideal interface between the ISM and the fluid-filled paper layers (i.e., an interface that has no air trapped in between and an evenly distributed pressure). On the contrary, the ISM in conventional measurements is in direct contact with the sample and the inner filling solution, and thus two stable liquid-membrane interfaces are formed. The relatively unstable interfaces in the ion-sensing EPADs affect the flux of ion of interest toward the ISM and disrupt the equilibrium ion distributions across the interface, which might be responsible for the minor drift in the detection range and the slope.

Miniaturized paper-based ISEs can be integrated with a paper-based reference electrode in an ion-sensing EPAD to enable the potentiometric measurement of electrolyte ions Cl⁻, Na⁺, K⁺, and Ca²⁺) in aqueous solutions. It is expected that the method and devise can be extended to other biomedically relevant ions, including but not limited to, Li⁺ and proton.

Similar rEPADs could also be fabricated to include a wider variety of ISMS, for sensing applications of other ions in environmental monitoring and quality control, such as measurements of Mg²⁺ in water hardness analysis and NO₃⁻ in water quality studies.

The combined capabilities of pipette-free sample introduction, multiplexing, and extended lifetime enable the microfluidic devices disclosed herein to be used in remote setting with only a portable potentiostat as supporting equipment.

### Experimental

Chemicals: Ag/AgCl ink (E2414) was purchased from Ercon Inc (Wareham, Mass.). Valinomycin (Potassium ionophore I), 4-tert-butylcalix[4] arene-tetraacetic acid tetraethyl ester (Sodium ionophore X), [N,N,N′,N′-tetracyclohexyl-3-oxapentanediamide] (ETH 129, Calcium ionophore II), potassium tetrakis(4-chlorophenyl)borate (KTpClPB), 2-nitrophenyl octyl ether (o-NPOE), poly(vinyl chloride) high molecular weight (PVC), and tetrahydrofuran (THF) were all purchased from Sigma-Aldrich or Fluka. PVC tubing (Tygon®, formulation R-3603) and rubber caps were purchased from VWR International.

Electrochemical Supplies:

A double-junction type external reference electrode (DX200; 3.0 M KCl saturated with AgCl as inner filling solution and 1.0 M LiOAc as bridge electrolyte) was purchased from Mettler Toledo. Ag/AgCl reference electrodes with 1 M KCl internal filling solution were purchased from CH Instruments, Inc.

Fabrication of the Paper Devices:

Paper-based zones and microfluidic channels were fabricated by patterning chromatography paper (Whatman 1 Chr) by wax printing. The electrodes were fabricated by stencil-printing Ag/AgCl ink on the wax-printed paper devices. A stencil for printing was generated by designing patterns of electrodes using AutoCAD® 2012, and the pattern was cut into frisket film (Grafix, low tack) using a laser-cutter (VersaLASER VLS3.50, Universal Laser Systems Inc.). The stencil was adhered on top of the paper, and the openings of the stencil were filled with ink. The ink was cured by baking the electrodes in an oven at 100° C. for 10 min.

Fabrication of the Ion-Selective Membranes (ISMS):

The ISMS were prepared following established literature protocols. A K⁺ ISM contains 1.4 wt % of Valinomycin, 0.3 wt % of KTpClPB, 32.8 wt % of PVC, and 65.5 wt % of o-NPOE. A Na⁺ ISM contains 1.0 wt % of sodium ionophore X, 0.3 wt % of KTpClPB, 32.9 wt % of PVC, and 65.8 wt % of o-NPOE. A Ca²⁺ ISM contains 1.0 wt % of ETH 129, 0.6 wt % of KTpClPB, 32.8 wt % of PVC, and 65.6 wt % of o-NPOE. The membranes were prepared by dissolving 0.2 g of the mixture into 1.5 mL of THF for 1K⁺Na⁺, and 0.4 g of the mixture into 4 MI, of THE for Ca²⁺. The THF solution was poured into a petri dish and the THF was let to evaporate for 24 h. The membrane was then cut into circular small pieces (10 mm in diameter) and conditioned by soaking overnight in solutions of the corresponding ion (K⁺, Na⁺, and Ca²⁺).

Potentiometric Measurements:

The inner filling solution, sample, and the external reference solution were spotted onto the corresponding zones. All potential measurements were performed at room temperature with an EMF 16 channel potentiometer (Lawson Labs, Inc., Malvern, Pa.). This instrument has a high input impedance (10¹³Ω) that is suitable for potentiometric measurements in which the ISM has a large resistance. Activity coefficients were calculated according to a two-parameter Debye-Huckel approximation. Alt EMF values were corrected for liquid-junction potentials with the Henderson equation.

Upon review of the description and embodiments of the present invention, those skilled in the art will understand that modifications and equivalent substitutions may be performed in carrying out the invention without departing from the essence of the invention. Thus, the invention is not meant to be limiting by the embodiments described explicitly above, and is limited only by the claims which follow.

What is claimed is:

1. A microfluidic, electrochemical device comprising
a first porous, hydrophilic layer comprising a sample zone;
a hydrophilic region comprising a reference zone; and
a microfluidic channel, wherein the microfluidic channel provides for predominantly diffusive fluid communication between the sample zone and the reference zone;
a fluid-impermeable material that defines each of the sample zone, reference zone and microfluidic channel;
a first electrode in fluid communication with the sample zone; and
a second electrode in fluid communication with the reference zone.

2. The microfluidic, electrochemical device of claim 1, wherein the second electrode is a reference electrode.

3. The microfluidic, electrochemical device of claim 2, wherein the reference electrode is a Ag/AgCl electrode.

4. The microfluidic, electrochemical device of claim 1, wherein the first and second electrodes are stencil printed on said hydrophilic layer.

5. The microfluidic, electrochemical device of claim 1, further comprising a third electrode in fluid communication with the sample zone.

6. The microfluidic, electrochemical device of claim 5, wherein the first and third electrodes are carbon electrodes comprising a working electrode and a counter electrode, respectively.

7. The microfluidic, electrochemical device of claim 1, wherein the microfluidic channel comprises a mixing zone.

8. The microfluidic, electrochemical device of claim 1, further comprising
a second sample zone and a second microfluidic channel defined by the fluid impermeable material, wherein the second microfluidic channel provides for predominantly diffusive fluid communication between the second sample zone and the reference zone.

9. The microfluidic, electrochemical device of claim 8, further comprising
a third sample zone and a third microfluidic channel defined by the fluid impermeable material, wherein the third microfluidic channel provides for predominantly diffusive fluid communication between the third sample zone and the reference zone.

10. The microfluidic, electrochemical device of claim 1, further comprising a sample inlet channel providing fluid communication from an edge of the porous, hydrophilic layer to the sample zone.

11. The microfluidic, electrochemical device of claim 1, further comprising a reference inlet channel providing fluid communication from an edge of the porous, hydrophilic layer to the reference zone.

12. The microfluidic, electrochemical device of claim 1, wherein the first and second electrodes are Ag/AgCl electrodes.

13. The microfluidic, electrochemical device of claim 1, wherein the first electrode comprises an indicator electrode and an ion-selective membrane separates the indicator electrode from the sample solution.

14. The microfluidic, electrochemical device of claim 1, further comprising an ion-selective membrane overlaying and contacting at least a portion of the first hydrophilic layer; and
a second porous, hydrophilic layer overlaying and contacting at least a portion of the ion-selective membrane, wherein the second hydrophilic layer comprises an inner filling zone defined by a fluid-impermeable material and the first electrode is disposed in the inner filling reference zone.

15. The microfluidic, electrochemical device of claim 14, wherein the ion-selective membrane comprises a polymer membrane matrix impregnated with a composition comprising an ionophore.

16. The microfluidic, electrochemical device of claim 14, wherein the ion-selective membrane comprises a polymer membrane matrix comprising PVC.

17. The microfluidic, electrochemical device of claim 1, wherein the first or second porous, hydrophilic layer comprises paper.

18. The microfluidic, electrochemical device of claim 1, wherein each of the sample zone, reference zone and microfluidic channel are disposed on the first hydrophilic layer.

19. The microfluidic, electrochemical device of claim 1, further comprising at least one outer support material.

20. A method of determining the presence and/or concentration of one or more analytes in a fluidic sample using the microfluidic, electrochemical device of claim 1 comprising:
introducing a fluidic sample into one of the one or more sample zones of the porous, hydrophilic layer to provide fluidic contact of the sample with an electrode in fluid communication with said sample zone;
introducing a reference solution into the reference zone to provide fluidic contact of the reference solution with the second electrode; and
measuring an electrochemical signal using the electrode(s).

21. A method of determining the presence and/or concentration of one or more analytes in a fluidic sample using the microfluidic, electrochemical device of claim 14, comprising:
introducing an inner filling solution into the inner filling zone to provide fluidic contact of the inner filling solution with the first electrode; and
introducing a fluidic sample into one sample zone of the porous, hydrophilic layer to provide fluidic contact of the sample with said sample zone;
introducing a reference solution into the reference zone to provide fluidic contact of the reference solution with the second electrode; and
measuring an electrochemical signal using the electrode(s).

22. The method of claim 21, wherein the electrochemical signal is correlated with a concentration of the analyte(s).

23. The method of claim 21, wherein the electrochemical signal is correlated with presence of the analyte(s).

24. The method of claim 21, wherein measuring an electrochemical signal comprises impedance measurement, current or voltage measurement.

25. The method of claim 21, wherein the electrochemical measurement is selected from the group consisting of amperometry, biamperometry, stripping voltammetry, differential pulse voltammetry, cyclic voltammetry, coulometry, chronoamperometry, and potentiometry.

26. The method of claim 21, wherein the electrochemical measurement is chronoamperometry and the analyte is selected from the group consisting of glucose, cholesterol, uric acid, lactate, blood gases, DNA, hemoglobin, nitric oxide, and blood ketones.

27. The method of claim 21 wherein the reference solution comprises KCl.

28. The method of claim 21 wherein the inner filling solution comprises iCl, where i is the electrolyte ion of interest in the electrochemical analysis.

29. A system comprising the microfluidic, electrochemical device of claim 1 and a device for measuring an electrochemical signal from said microfluidic, electrochemical device.
